(19) United States
(12) Patent Application Publication
(10) Pub. No.: US 2022/0030986 A1
(43) Pub. Date: Feb. 3, 2022

(54) SYSTEM AND METHOD FOR MAKING ONE-PIECE PROTECTIVE SPORTS ARTICLES

(71) Applicant: TRUE TEMPER SPORTS, INC., Memphis, TN (US)

(72) Inventors: Matthew WINNINGHAM, Royal Oak, MI (US); Jerry SCOTT, Royal Oak, MI (US)

(73) Assignee: TRUE TEMPER SPORTS, INC., Memphis, TN (US)

(21) Appl. No.: 17/275,700

(22) PCT Filed: Sep. 30, 2019
(86) PCT No.: PCT/US2019/053841

§ 371 Date: Mar. 12, 2021

Related U.S. Application Data
(60) Provisional application No. 62/739,431, filed on Oct. 1, 2018.

(51) Int. Cl. A41D 19/015

(52) U.S. Cl. CPC A41D 19/015

(57) ABSTRACT

A system and method for creating protective sports articles. The system includes a last. A liner of flexible material that defines a pocket is provided. A plurality of padding pieces are provided that each have a bottom surface and an adhesive disposed over the bottom surface. The method includes inserting the last into the pocket of the liner. The method also includes positioning the bottom surface of each of the padding pieces over the liner to engage the adhesive against the liner. The method further includes applying pressure to the padding pieces to bond the adhesive of the padding pieces to the liner to secure the padding pieces to the liner and to form a completed article. The method further includes removing the completed article from the last.

### CROSS-REFERENCE TO RELATED APPLICATIONS

The present disclosure is a PCT International Application of U.S. Provisional Patent Application No. 62/739,431, filed on Oct. 1, 2018. The entire disclosure of the application referenced above is incorporated herein by reference.

### FIELD

The present disclosure relates to systems and methods for creating protective sports articles and, more particularly, to systems and methods for creating one-piece protective sports articles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Protective sports articles, such as pads and gloves are used in sports such as hockey, lacrosse, and football. Assembly of such protective articles may include a process in which numerous padding pieces are stitched to a base liner. Such processes typically take a significant amount of time, suffer from quality issues because they are not easily repeatable, and can be expensive to perform as they are labor intensive. Accordingly, there remains room for improvements to such systems and methods for making protective sports articles.

### SUMMARY

It is an aspect of the disclosure to provide a system for making one-piece protective sports articles that is inexpensive.

It is another aspect of the disclosure to provide a system for making one-piece protective sports articles that is easily duplicated with a high degree of precision.

It is another aspect of the disclosure to provide a system for making one-piece protective sports articles that is efficient and easily automated.

It is another aspect of the disclosure to provide a system for making one-piece protective sports articles that is easily customizable to make protective sports articles of different sizes and configurations for specific individuals.

According to these and other aspects of the disclosure, a system for creating protective sports articles is provided. The system includes a molded last that is shaped like a desired final protective sports article. A liner is shaped to fit over the last and is positioned about the last. A plurality of padding pieces are connected to the liner. Each of the padding pieces have a base presenting an adhesive which is positioned against the liner to secure the padding pieces to the liner.

According to the aforementioned and other aspects of the disclosure, a method for creating protective sports articles is provided. The method includes providing a molded last being shaped like a desired final protective sports article. The method continues with providing a liner of flexible material that defines a pocket. The method proceeds by inserting the last into the pocket of the liner to fix the liner about the last. The method further includes providing a plurality of padding pieces, each having a bottom surface and an adhesive disposed over the bottom surface. The method also includes positioning the bottom surface of each of the padding pieces over the liner to engage the adhesive against the liner. The method continues with applying pressure to the padding pieces to bond the adhesive to the liner to secure the padding pieces to the liner and to form a completed article. The method also includes removing the completed article from the last.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is an exploded perspective view of a last according to an aspect of the disclosure, illustrating a thumb portion of the last being separated from a palm portion of the last;

FIG. 2 is a perspective view of the last, illustrating the thumb portion being connected to the palm portion;

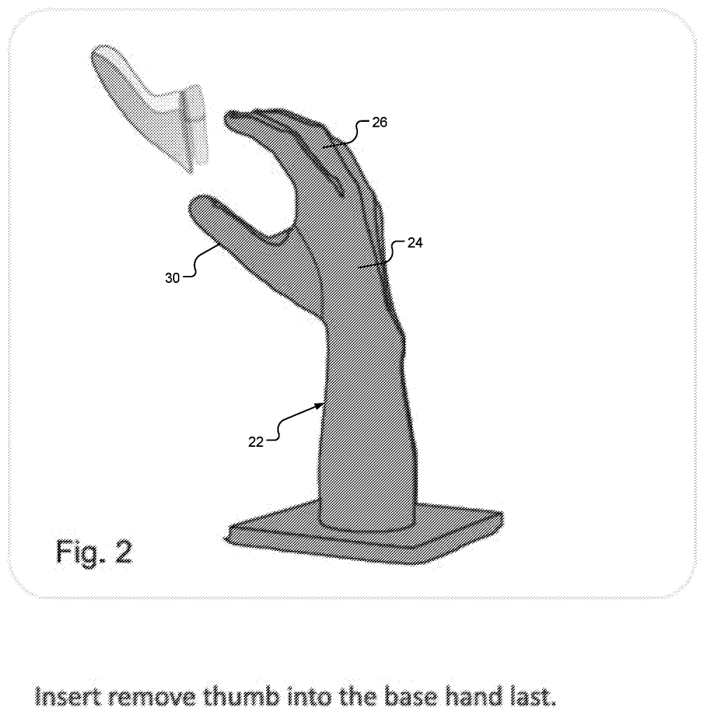

FIG. 3 is a perspective view of the thumb portion of the last and an example embodiment of a liner disposed adjacent to the thumb portion;

FIG. 4 is a perspective of the liner disposed approaching and covering the last;

FIG. 5 is an exploded perspective view of the liner disposed about (covering) the last and a plurality of padding pieces before the padding pieces are adhered to the liner;

FIG. 6 is a perspective view of the last and the plurality of padding pieces secured to the liner to form a completed protective sports article;

FIG. 7 is an exploded perspective view of the protective sports article being disconnected from the last with the thumb portion of the last being disconnected from the palm portion and positioned in the protective sports article;

FIG. 8 is a perspective exploded view of the protective sports article with the thumb portion of the last being removed from the protective sports article;

FIG. 9 includes front and back perspective views of a finished protective sports article; and

FIG. 10 is a flow diagram illustrating an example method of making a one-piece protective sports article.

In the drawings, reference numbers may be reused to identify similar and/or identical elements.

### DETAILED DESCRIPTION

Referring to the figures, like numerals indicate corresponding parts throughout the several views, and a system and method for creating protective sports articles 20 are generally shown. The system and method described herein may be utilized to make various different types of protective sports articles 20 including, but not limited to, gloves and pads for use in various sports such as hockey, lacrosse, and football.

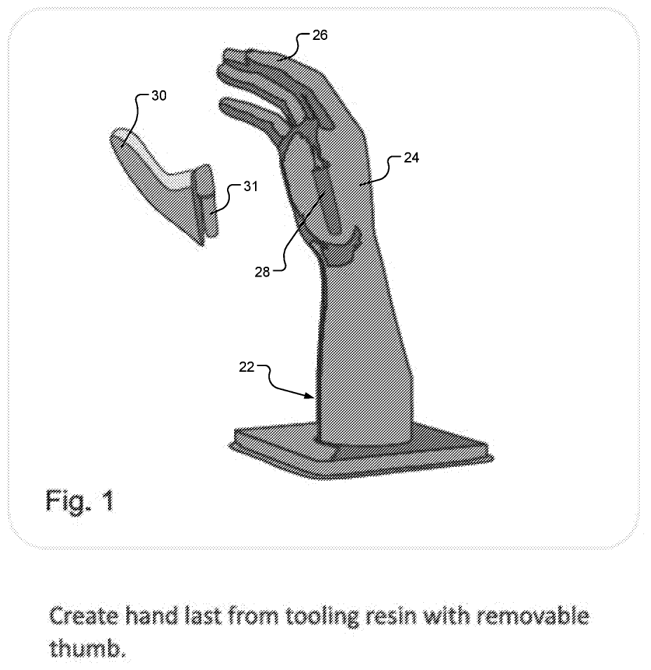

As illustrated in FIG. 1, the system includes a last 22. According to the example embodiment, the last 22 may be made of a tooling resin material. It should be appreciated that the last 22 could be made of various other molded materials. Because the last 22 is made of a molded material, it may be sized and shaped to represent a part of a user's body. For example, the last 22 may be sized and shaped like a user's hand in order to ultimately make a glove that is specifically adapted to fit the user's hand. It should be appreciated that prior to making the last 22, measurements of a specific user may be acquired to build a custom last that is sized for the user. Different sizes of lasts may be used to make different sizes of protective articles.

According to the example embodiment, the last 22 may have the shape of a hand and may include a palm portion 24 and a plurality of finger portions 26 that extend from the palm portion 24. The palm portion 24 may define a slot 28. A thumb portion 30 may be removeably attached to the palm portion 24. More particularly, the thumb portion 30 may include a tab 31 that is slideably disposed in the slot 28 of the palm portion 24. It should be appreciated that other portions of the last 22 maybe removeably connected to one another in a similar manner depending on specific needs.

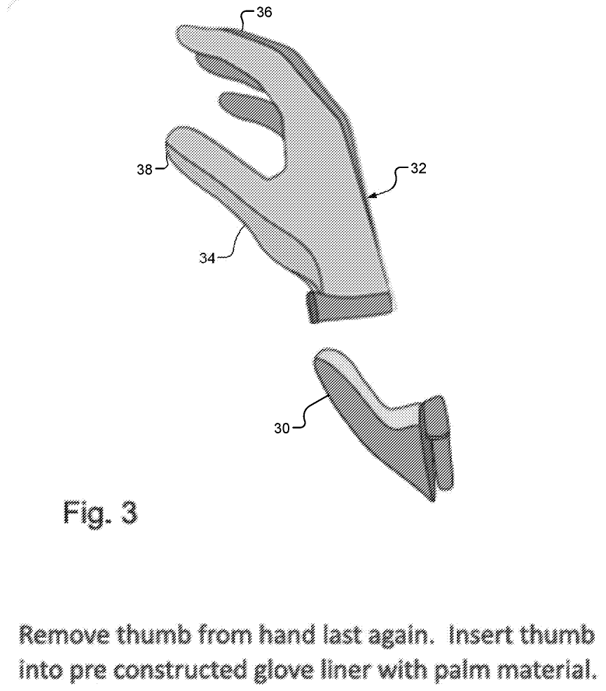

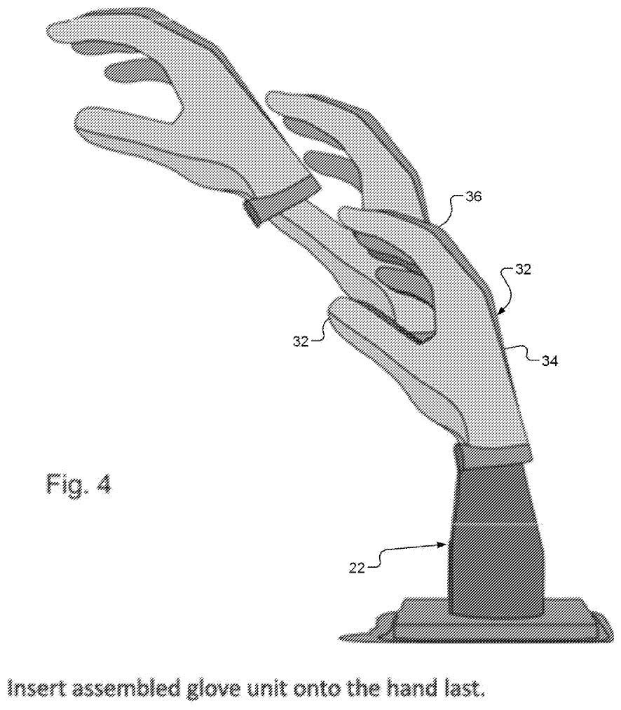

As illustrated in FIGS. 3 and 4, a liner 32 is shaped and sized to fit over the last 22. In the example of the last 22 having the shape of a hand, the liner 32 also has the shape of a hand/glove.

The liner 32 may have a palm portion 34, a plurality of finger portions 36 extending from the palm portion 34, and a thumb portion 38 extending from the palm portion 34. The palm portion 34 is shaped to receive the palm portion 24 of the last 22, the finger portions 36 are shaped to receive the finger portions 26 of the last 22, and the thumb portion 38 is shaped to receive the thumb portion 30 of the last 22.

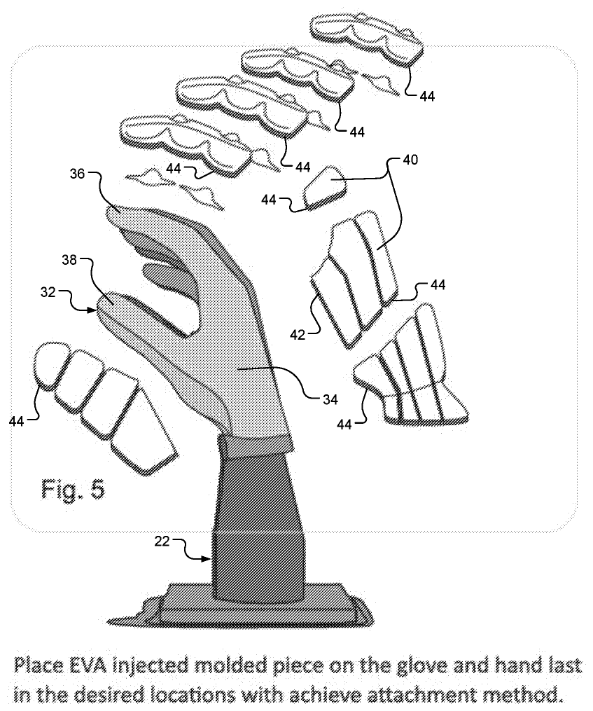

As illustrated in FIG. 5, a plurality of padding pieces 40 are provided. Each of the padding pieces 40 has a base 42 for overlying the liner 32. The padding pieces 40 may be made of a foam material, such as an Ethylene-Vinyl Acetate (EVA) injected foam, or another suitable type of material. An adhesive 44 is disposed over the base 42 of each of the padding pieces 40 for securing the padding pieces 40 to the liner 32. For example, the adhesive 44 may be applied to inner surfaces of the bases 42 of the padding pieces 40.

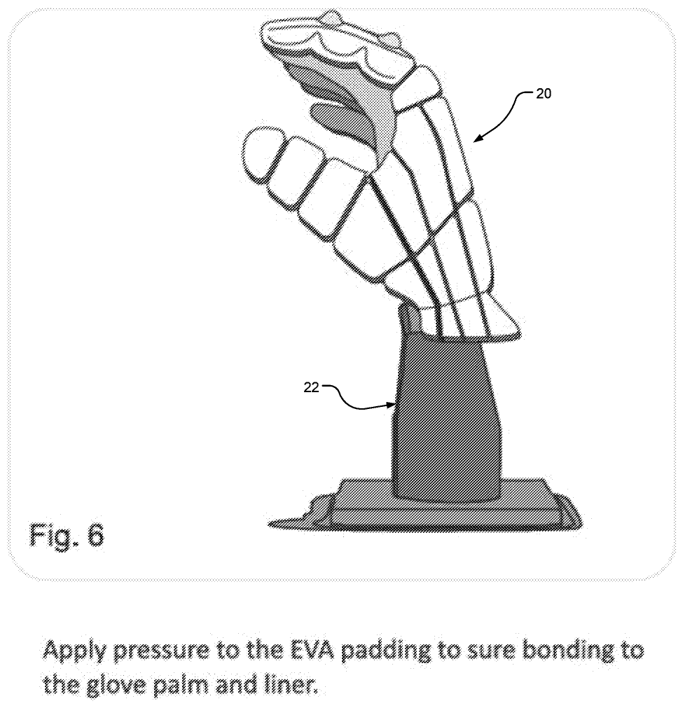

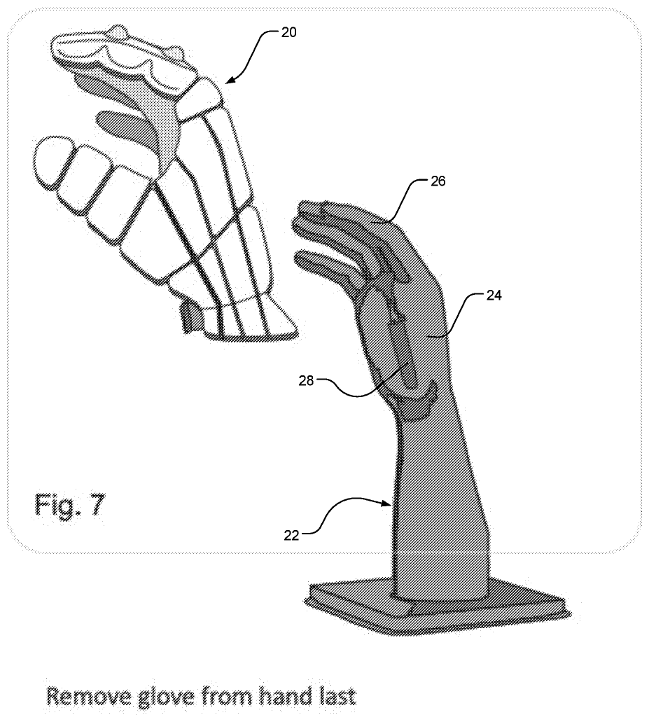

Pressure can be applied, as shown in FIG. 6, to ensure proper bonding of the padding pieces 40 to the liner 32. Once the padding pieces 40 have been secured to the liner 32, the protective sports article 20 can be removed from the last 22. Removal of the protective sports article 20 from the last 22, however, may cause the thumb portion 30 to be detached from the last 22. The thumb portion 30 may be retained within the thumb portion 38, as shown in FIG. 7.

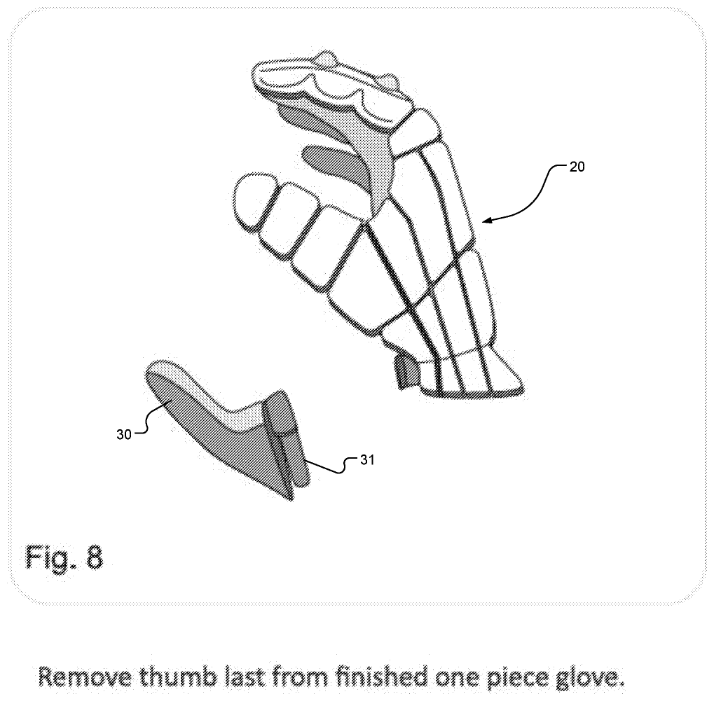

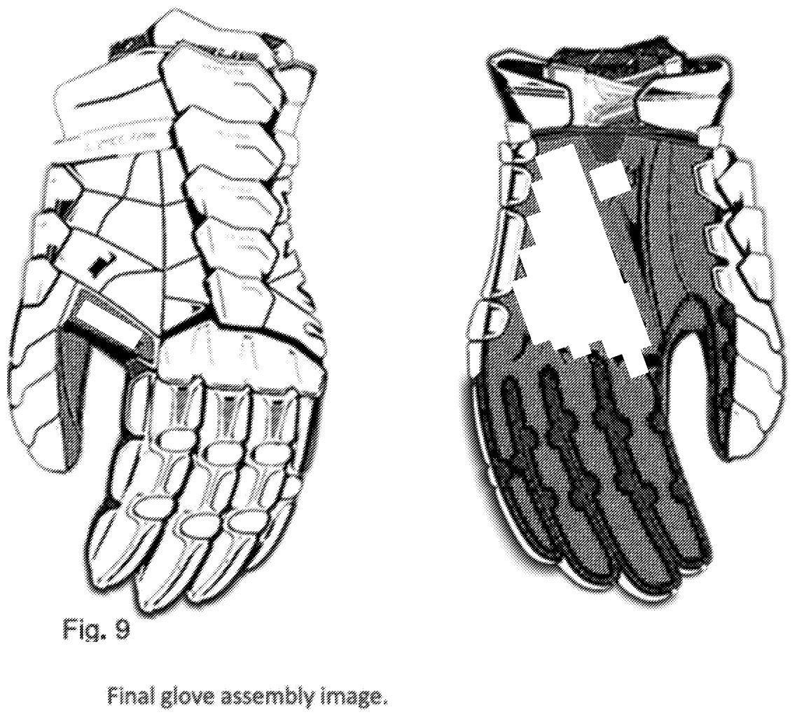

As shown in FIG. 8, the thumb portion 30 may be removed from the thumb portion 38 after the protective sports article 20 has been removed from the last 22. As shown in FIG. 9, once the padding pieces 40 have been secured to the liner 32, a completed, one-piece protective sports article 20 is formed. Additional finishing elements may be added to the protective sports article 20 as desired.

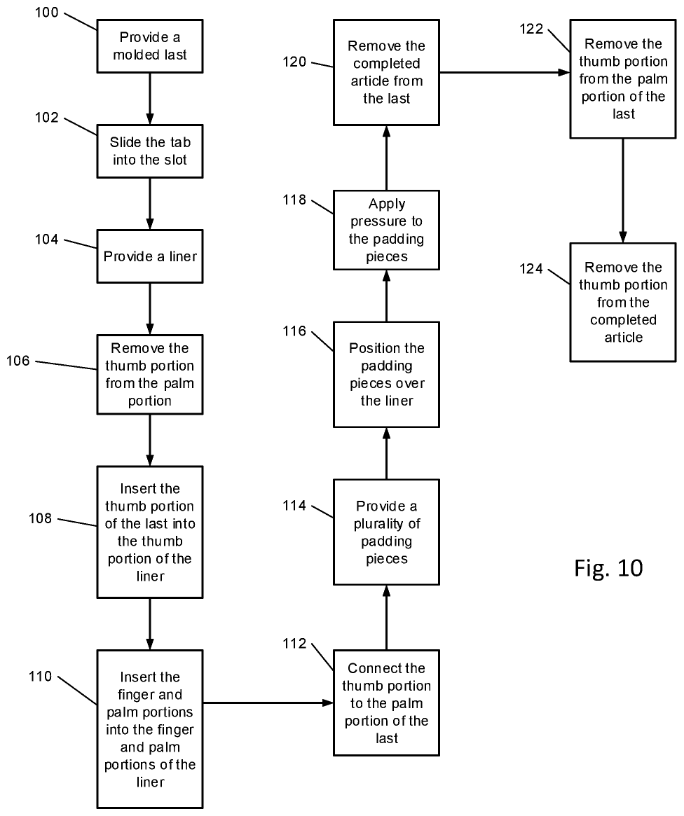

With reference to FIG. 10, a method of creating protective sports articles 20 is provided. The method may include 100 providing a molded last 22. As previously discussed, the last 22 may generally have a hand shape and include a palm portion 24, a plurality of finger portions 26 extending from the palm portion 24, and a thumb portion 30 being removeably attached to the palm portion 24. The palm portion 24 may define a slot 28. The thumb portion 30 may have a tab 31 that is slideably received in the slot 28. In the example of shoulder pads, the last 22 may be torso shaped and may or may not include arms. In this example, the liner 32 would also include the shape of a torso and may or may not include arms.

The method may further include 102 sliding the tab 31 of the thumb portion 30 into the slot 28 of the palm portion 24. Removing the thumb portion 30 of the last 22 from the palm portion 24 and inserting the thumb portion 30 into the thumb portion 38 of the liner 32 may provide space for the remaining portions of the last 22 to be inserted into the liner 32. In various implementations, 102 may be omitted.

The method continues with 104 including providing a liner 32 of flexible material and defining a pocket. The liner 32 may have a palm portion 34, a plurality of finger portions 36, and a thumb portion 38. The method continues with 106 including removing the thumb portion 30 of the last 22 and 108 inserting the thumb portion 30 of the last 22 through the palm portion 34 and into the thumb portion 38 of the liner 32. The method continues by 110 inserting the finger portions 26 and the palm portion 24 of the last 22 into finger portions 36 and palm portion 34 of the liner 32. The method also includes 112 sliding the thumb portion 30 of the last 22 into the slot 28 of the palm portion 24 to connect the thumb portion 30 to the palm portion 24.

The method further includes 114 providing a plurality of padding pieces 40 each having a bottom surface (a base) 42 and an adhesive 44 disposed over (covering) the bottom surface 42. The method proceeds with 116 including positioning the bottom surface 42 of each of the padding pieces 40 at respective locations on the liner 32 to engage the adhesive 44 against the liner 32 and to adhere the padding pieces 40 to the liner 32.

The method proceeds with 118 including applying pressure to the padding pieces 40 to bond the adhesive 44 of the padding pieces 40 to the liner 32 to secure the padding pieces 40 to the liner 32 and to form a completed article 20. The method may also include heating to adhere the adhesive 44 (and the padding pieces 40) to the liner 32.

The method continues by 120 removing the completed article 20 from the last 22. Removing the completed article 20 from the last 22 includes may include 122 sliding the tab 31 of the thumb portion 30 out of the slot 28 of the palm portion 24. Finally, the method may include 124 removing the thumb portion 30 of the last 22 from the completed article 20. The method may be repeated to form another completed article.

While the example of the right hand glove is provided, the present application is also applicable to left hand gloves. Also, while the above-described method is directed to an assembly process for making a glove, similar steps may be executed to create other protective sports articles including, but not limited to, shin pads and shoulder pads. In the examples of other types of protective sports articles, the last 22 and the liner may be shaped based on the portion of the body to be protected.

It should also be appreciated that the subject system and method may be executed without the use of stitching, as may otherwise be used in making protective sports articles. Therefore, the assembly process of the present application is simplified, thus leading to cheaper manufacturing and material costs.

It should also be appreciated that the subject system and method allow protective articles to easily be customized by creating a custom last 22 prior to the rest of the protective article 20. More particularly, specific measurements of a user may be obtained and the last may be constructed in accordance with the measurements to provide higher performance protective articles.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A protective sports article comprising:
a liner of a flexible material, the liner being shaped to fit over a molded last and cover the molded last; and
a plurality of padding pieces, each of the plurality of padding pieces including a base surface and an adhesive covering the base surface, the plurality of padding pieces being adhered to the liner at respective locations via the adhesive.

2. The protective sports article of claim 1 wherein the plurality of padding pieces include a foam.

3. The protective sports article of claim 1 wherein the plurality of padding pieces include an Ethylene-Vinyl Acetate (EVA) injected foam.

4. The protective sports article of claim 1 wherein the plurality of padding pieces are adhered to the liner without any stitching.

5. The protective sports article of claim 4 wherein the protective sports article does not include any other padding pieces.

6. The protective sports article of claim 1 wherein the liner has the shape of a hand.

7. A method of manufacturing a protective sports article, the method including:
positioning a liner over a last, the liner being made of a flexible material and defining an interior pocket, a portion of the last being disposed within the interior pocket when the liner is positioned over the last;
applying a plurality of padding pieces to the liner at respective locations, the plurality of padding pieces each including a base surface and an adhesive covering base surface,
wherein the applying includes applying the adhesive of the plurality of padding pieces to the liner;
applying pressure to the plurality of padding pieces, thereby adhering the plurality of padding pieces to the liner via the adhesive and forming the protective sports article; and
removing the protective sports article from the last.

8. The method of claim 7 wherein the protective sports article includes a sports glove.

9. The method of claim 8 wherein the liner has the shape of a hand.

10. The method of claim 9 further comprising, before the positioning of the liner over the last, inserting a thumb portion of the last into a thumb portion of the liner.

11. The method of claim 10 further comprising, after the inserting the thumb portion of the last into the liner and after the positioning of the liner over the last, inserting a tab on a thumb portion of the last into a slot in a palm portion of the last.

12. The method of claim 11 wherein removing the protective sports article from the last includes:
removing the tab on the thumb portion of the last from the slot in the palm portion of the last while the protective sports article is disposed on the last; and
removing the protective sports article from the last while the thumb portion of the last is disposed within the thumb portion of the liner.

13. The method of claim 12 wherein removing the protective sports article from the last further includes removing the thumb portion of the last from the thumb portion of the liner.

14. The method of claim 10 wherein the last has the shape of a hand.

15. The method of claim 10 wherein positioning the liner over the last includes positioning finger portions of the last within finger portions of the liner.

16. The method of claim 15 wherein positioning the liner over the last includes positioning a palm portion of the last within a palm portion of the liner.

17. The method of claim 7 wherein the plurality of padding pieces are adhered to the liner without any stitching, and wherein the protective sports article does not include any other padding pieces.

18. A method of manufacturing a protective sports article, the method including:
(a) inserting a thumb portion of a last into a thumb portion of a liner,
wherein the last has shape of a hand, and
wherein the liner is made of a flexible material and has the shape of a hand;
after (a), (b) positioning the liner over the last including positioning finger portions of the last within finger portions of the liner and positioning a palm portion of the last within a palm portion of the liner;
after (b), (c) inserting a tab on the thumb portion of the last into a slot in the palm portion of the last;
after (c), (d) applying a plurality of padding pieces to the liner at respective locations, the plurality of padding pieces each including a base surface and an adhesive covering the base surface,
wherein the applying includes applying the adhesive of the plurality of padding pieces to the liner; and
after (d), (e) applying pressure to the plurality of padding pieces, thereby adhering the plurality of padding pieces to the liner via the adhesive.

19. The method of claim 18 further comprising, after (e), (f) removing the liner with the plurality of padding pieces adhered from the last.

20. The method of claim 19 wherein (f) includes removing the liner with the thumb portion of the last still within in the thumb portion of the liner, and
wherein the method further includes removing the thumb portion of the last from the thumb portion of the liner.
